(19) United States
(12) Patent Application Publication
(10) Pub. No.: US 2026/0149692 A1
(43) Pub. Date: May 28, 2026

(54) CONTEXT AWARE DEVICE IDENTITY DISTRIBUTION IN OVERLAY NETWORKS

(71) Applicant: Palo Alto Networks, Inc., Santa Clara, CA (US)

(72) Inventors: Venkata Sarat Kumar Vajrapu, Bengaluru (IN); Anil Kumar Reddy Sirigiri, Bengaluru (IN); Arunkumar Desigan, Bengaluru (IN); Vamsidhar Valluri, Los Gatos, CA (US)

(21) Appl. No.: 18/961,028

(22) Filed: Nov. 26, 2024

(51) Int. Cl. H04L 9/40; H04L 67/12

(52) U.S. Cl. CPC H04L 63/0236; H04L 67/12

(57) ABSTRACT

The present application discloses a method, system, and computer system for distributing to network edges relevant IP to device mappings and causing a relevant policy to be applied to a set of Internet of Things (IoT) devices at network edge or branch. The method includes: (a) determining IP-device mappings for a set of IoT devices; (b) filtering the IP-device mappings for a subset of IoT devices associated with a particular network edge to obtain a mapping of IPs to IoT devices associated with the particular network edge; (c) providing to the particular network edge the mapping of IPs to IoT devices associated with the particular network edge; and (d) causing a relevant policy to be applied at the particular network edge based on the subset of IoT devices associated with the particular network edge.

### BACKGROUND OF THE INVENTION

The rapid growth of Internet of Things (IoT) devices has significantly increased the number of devices connected to enterprise networks. These devices, ranging from sensors and actuators to smart appliances, communicate over networks using Internet Protocol (IP) addresses. Managing and securing such a vast and dynamic array of devices presents considerable challenges for network administrators, especially when it comes to enforcing network policies and ensuring efficient traffic management.

### BRIEF DESCRIPTION OF THE DRAWINGS

Various embodiments of the invention are disclosed in the following detailed description and the accompanying drawings.

FIG. 1 is a block diagram of an environment for managing a mapping of IP addresses to Internet of Things (IoT) devices according to various embodiments.

FIG. 2 is a block diagram of a system for enforcing policies at a network edge according to a set of relevant mappings of IP addresses to IoT devices according to various embodiments.

FIGS. 3A-3D are examples of IP to device mappings according to various embodiments.

FIGS. 4A and 4B are collectively a block diagram of a system for enforcing policies at a network edge according to a set of relevant mappings of IP addresses to IoT devices according to various embodiments.

FIG. 5 is a flow diagram of a method for providing a mapping of IPs to IoT devices associated with a particular network edge according to various embodiments.

FIG. 6 is a flow diagram of a method for enforcing a policy with respect to network traffic based on a mapping of IPs to IoT devices associated with a particular network edge according to various embodiments.

FIG. 7 is a flow diagram of a method for determining whether a policy is to be performed at a particular network edge according to various embodiments.

FIG. 8 is a flow diagram of a method for determining mapping of IPs to devices applicable for a particular network edge according to various embodiments.

FIG. 9 is a flow diagram of a method for causing a set of policies to be enforced at a particular network edge based on a mapping of IPs to devices relevant for the particular network edge according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security entity may be implemented as an application running on a device, such as an anti-malware application.

As used herein, an Instant-On Network (ION) device may include a type of network edge appliance commonly used in Software-Defined Wide Area Network (SD-WAN) architectures to intelligently manage and optimize data traffic between local networks and external networks such as the internet or cloud services. ION devices can be designed to dynamically route network traffic based on application policies, real-time network conditions, and organizational priorities. An ION device can incorporate features such as application-aware routing, bandwidth optimization, and security enforcement to enhance overall network performance and reliability. By operating at the edge of the network, ION devices enable connection of branch offices or remote sites to the central enterprise network, ensuring efficient, secure, and policy-compliant data transmission across the organization's network infrastructure.

As used herein, an Internet of Things (IoT) device may include a physical object equipped with sensors, software, and other technologies that enable it to connect to the internet or other communication networks. IoT devices can collect and exchange data with other devices or systems, often operating autonomously without direct human intervention. IoT devices can be used to perform functions, automate processes, or provide insights by integrating data from various sources, thereby improving efficiency, safety, and convenience in different environments. IoT devices can encompass a wide range of applications across multiple industries, including smart-homes, industrial, security, transport (e.g., smart vehicles), health care, environmental monitoring, etc. Examples of IoT devices include a smart thermostat, smart lighting systems, wearable devices, smartwatches, industrial sensors such as to monitor manufacturing performance, cameras, doorbells, alarm systems, smart cars, smart health monitors (e.g., glucose monitors, blood pressure monitors), environmental sensors (e.g., to monitor air quality, noise levels, traffic patterns, or energy consumption, etc.).

As used herein, a source device-based policy may include a policy that may be enforced by a security service (e.g., an ION device, a firewall, a security entity, etc.) based on the identity or attributes of the originating device. For example, the source device-based policy may comprise a set of rules or controls applied to network traffic based on the identity or attributes of the originating device. According to various embodiments, the system can use a mapping of IP addresses to devices to identify the source device from which network traffic originates. The network edge device, such as an ION device or firewall, then enforces policies specific to that device or its type. For example, the policy might restrict certain devices from accessing sensitive network resources, limit the bandwidth available to non-critical devices, or require enhanced authentication for devices classified as remote. By applying policies based on the source device, the system can ensures that network access and resources are allocated and secured according to organizational requirements, enhancing both security and efficiency.

As used herein, a destination device-based policy may include a policy that may be enforced by a security service (e.g., an ION device, a firewall, a security entity, etc.) based on the identity or characteristics of the device intended to receive the data. The destination device-based policy may include a set of rules or controls applied to network traffic based on the identity or characteristics of the device intended to receive the data. According to various embodiments, the system can use a mapping of IP addresses to devices to identify the destination device to which network traffic is directed. The network edge device, such as an ION device or firewall, then enforces policies specific to that destination device or its type. For example, the policy might restrict certain source devices or users from accessing sensitive destination devices, limit the types of permitted interactions, or require additional authentication steps for accessing critical infrastructure components. By applying policies based on the destination device, the system ensures that access to important resources is appropriately controlled, enhancing security and compliance with organizational protocols.

Traditional network management systems often rely on distributing complete mappings of IP addresses to devices across all network edges or nodes. In large-scale enterprise environments, this approach can be inefficient and resource-intensive. For example, if an enterprise has millions of devices, pushing the entire mapping to every network edge can consume excessive bandwidth and processing resources. Moreover, not all devices are relevant to every network edge, leading to unnecessary data distribution and potential security risks.

Existing solutions lack the ability to intelligently filter and distribute only the relevant IP-to-device mappings to specific network edges. This limitation hampers the network's ability to enforce localized policies effectively and respond promptly to security threats or access requests from remote devices.

Various embodiments address these challenges by implanting a system, method, and/or technique for dynamically determining and distributing mappings of IP addresses to devices, specifically tailored to the relevance of each network edge. The system can implement a centralized controller that learns the IP-to-device mappings from various IoT devices within the network. Each mapping may include a unique identifier of the device, such as a serial number, device ID, name, or MAC address.

Various embodiments provide a method, system, and computer system for distributing to network edges relevant IP to device mappings and causing a relevant policy to be applied to a set of Internet of Things (IoT) devices at network edge or branch. The method includes: (a) determining IP-device mappings for a set of IoT devices; (b) filtering the IP-device mappings for a subset of IoT devices associated with a particular network edge to obtain a mapping of IPs to IoT devices associated with the particular network edge; (c) providing to the particular network edge the mapping of IPs to IoT devices associated with the particular network edge; and (d) causing a relevant policy to be applied at the particular network edge based on the subset of IoT devices associated with the particular network edge.

Various embodiments provide a method, system, and computer system for distributing to network edges relevant IP to device mappings and causing a relevant policy to be applied to a set of Internet of Things (IoT) devices at network edge or branch. The method includes: (a) determining IP-device mappings for a set of IoT devices; (b) filtering the IP-device mappings for a subset of IoT devices associated with a particular network edge to obtain a mapping of IPs to IoT devices associated with the particular network edge; (c) providing to the particular network edge the mapping of IPs to IoT devices associated with the particular network edge; and (d) providing one or more policies to be enforced at the particular network edge.

In some embodiments, the system (e.g., a central controller that distributes the IP-to-device mappings to network edges, such as ION devices) classifies a device as either local or remote relative to a particular site or branch. Local devices may include those devices that are physically or logically connected to a specific network edge. Conversely, remote devices may include devices that are outside that local network segment but may require access to local resources. By distinguishing between local and remote devices, the system can selectively distribute only the relevant IP-to-device mappings to each network edge.

In some embodiments, a network edge device (e.g., an ION device) at a branch office will receive (e.g., from the system, or central controller) IP-to-device mappings for devices that are local to that branch and specific remote devices that may interact with the local network. This targeted distribution reduces the amount of data each network edge must handle, enhancing efficiency and scalability.

Upon receiving network traffic, the network edge device intercepts data packets and extracts the source or destination IP address. The network edge device then references the received mapping to identify the associated device. Based on predefined policies applicable to certain devices or device types, the network edge can enforce security measures, access controls, or other policy-driven actions.

The techniques according to various embodiments enable efficient data distribution by filtering and distributing only relevant IP-to-device mappings, conserving bandwidth and processing resources across the network. The system supports scalability in large-scale enterprise networks with millions of devices by preventing overload of network edges with irrelevant data. It also allows for dynamic policy enforcement, enabling network edges to quickly adapt to policy changes and enforce rules based on up-to-date mappings of local and specific remote devices. For example, the specific remote devices are pushed based on the destination device configuration in the policies attached to the network edge. Improved network performance and responsiveness result from the reduction of unnecessary data transfer.

According to various embodiments, the edge device operating at a particular network edge implements ION functionality and/or firewall functionality. For example, the edge device operates as both an Intelligent Optical Network (ION) device and a security entity such as a firewall (e.g., a next generation firewall), integrating advanced networking and security functionalities within a single system. As an ION device, it intelligently manages and optimizes data traffic between local networks and external networks such as the internet or cloud services. It dynamically routes network traffic based on application policies, real-time network conditions, and organizational priorities, ensuring efficient and reliable data transmission. This includes features like application-aware routing, bandwidth optimization, and traffic prioritization, which enhance overall network performance and responsiveness. Simultaneously, the edge device functions as a firewall, enforcing security policies that protect the network from unauthorized access, malicious activities, and data breaches. It analyzes incoming and outgoing traffic to identify and block threats, applying rules based on criteria like source and destination IP addresses, protocols, and application types. By integrating firewall capabilities, the device can control access to network resources, perform deep packet inspections, and implement intrusion prevention measures directly at the network edge.

According to various embodiments, based on the Destination devices configured in policy, the controller (e.g., a SDWAN controller) will filter and push only those IP-device mappings matching the one configured in a policy to an ION device (e.g., an SDWAN ION). In this case, these IoT devices need not be behind the ION device. Rather, they can be anywhere in the network, and traffic to those remote IoT devices can be enforced at the ION device.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QoS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks'PA Series firewalls).

For example, Palo Alto Networks'next generation firewalls enable enterprises to identify and control applications, users, and content-not just ports, IP addresses, and packets-using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provide higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

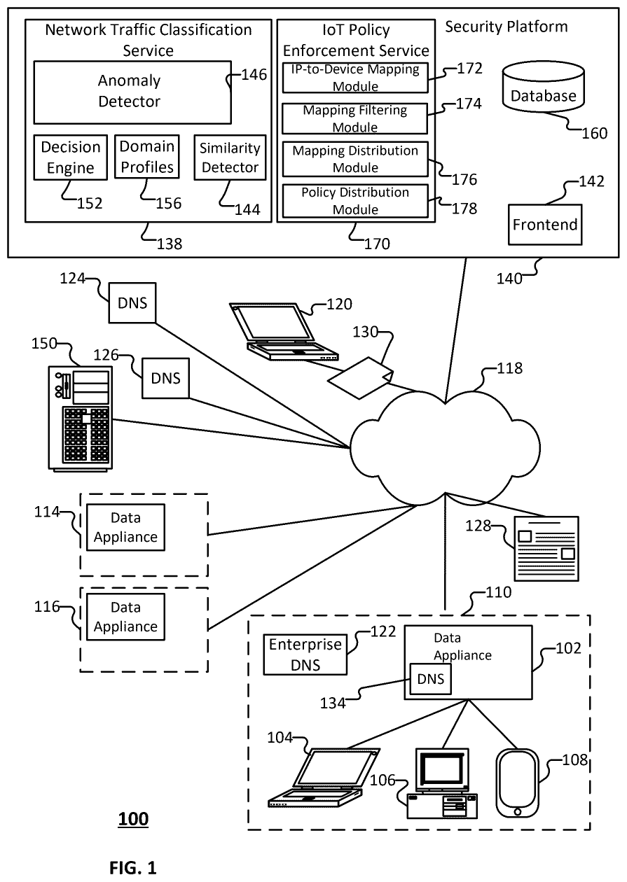

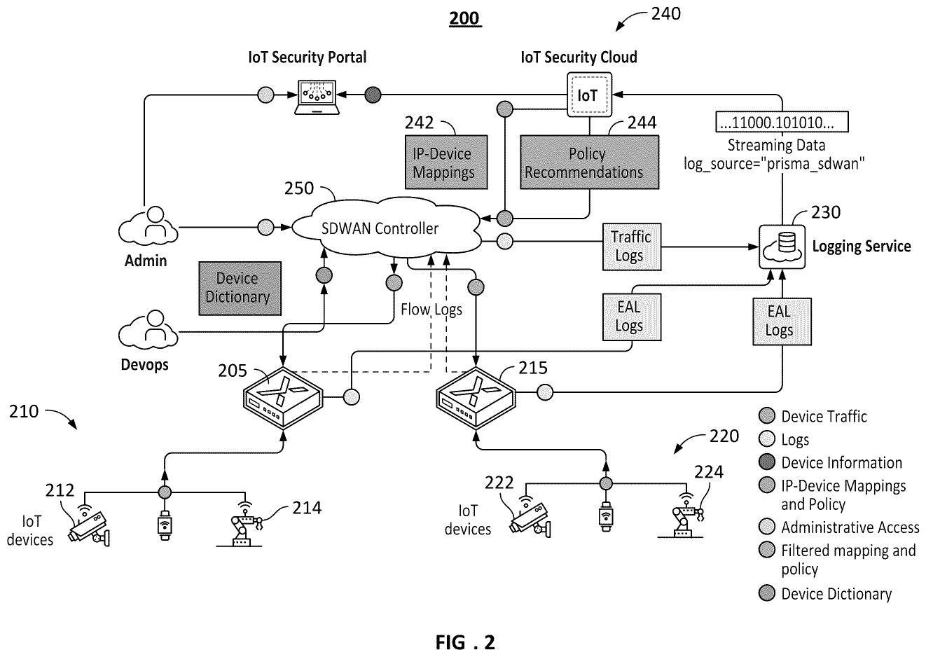

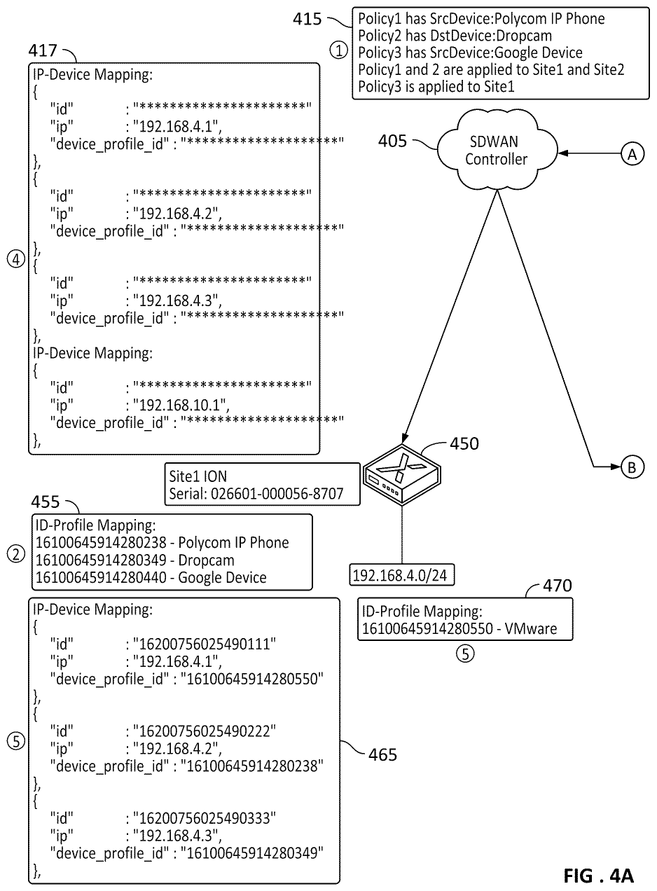

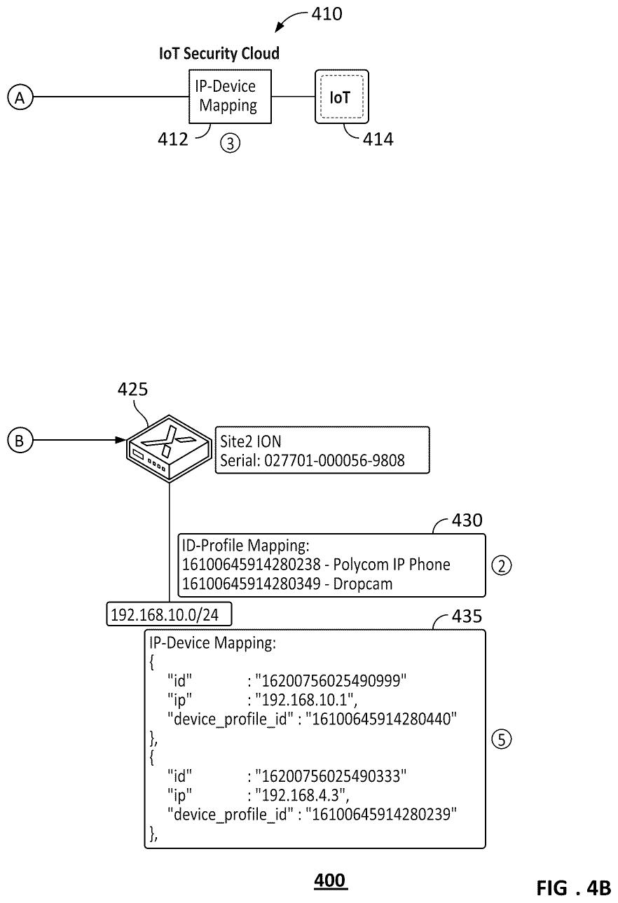

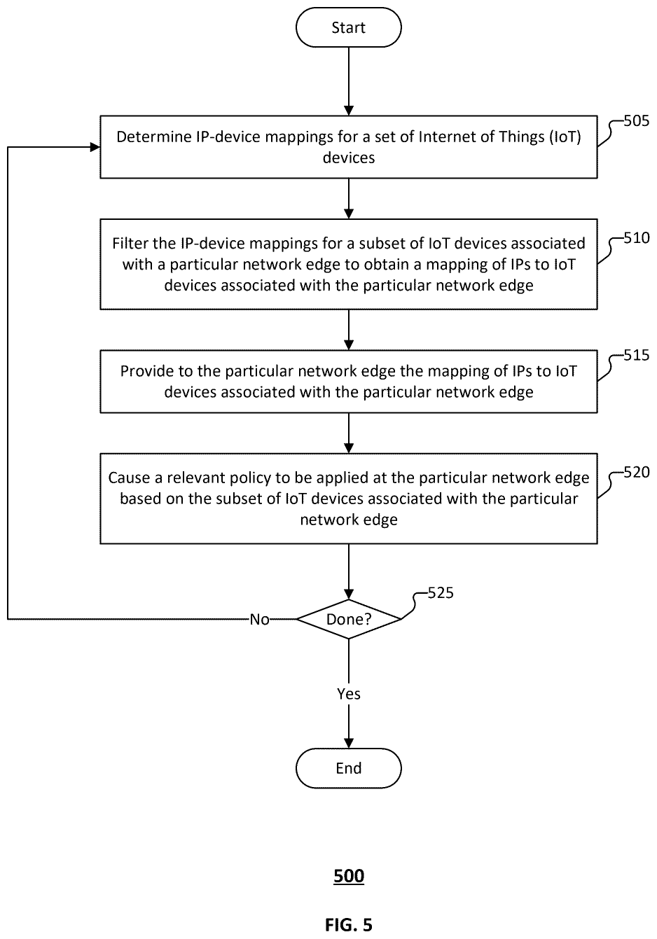

FIG. 1 is a block diagram of an environment for managing a mapping of IP addresses to Internet of Things (IoT) devices according to various embodiments. In some embodiments, system 100 implements at least part of system 200 of FIG. 2 and/or system 400 of FIGS. 4A and 4B. System 100 can implement one or more of processes 500-900 of FIGS. 5-9.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110. In some embodiments, data appliance 102 is a network edge device. For example, data appliance 102 can implement ION device functionality, security services (e.g., firewall functionality), etc.

Techniques described herein can be used in conjunction with a variety of platforms (e.g., desktops, mobile devices, gaming platforms, embedded systems, etc.) and/or a variety of types of applications (e.g., Android . ask files, iOS applications, Windows PE files, Adobe Acrobat PDF files, Microsoft Windows PE installers, etc.). In the example environment shown in FIG. 1, client devices 104-108 are endpoints, such as a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacked record, etc.), classifying network traffic, providing a mapping of signatures to certain domains or DNS records (e.g., a DNS record for which a predicted likelihood that the record is a DNS hijacked record exceeds a predefined likelihood threshold, etc. a mapping of domains or DNS records to domain or DNS record data (e.g., domain certificates, pen's data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacked record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacked records or malicious domains (e.g., an on-demand detection, or periodical-based updates to a mapping of domains or DNS records to indications of whether the domains or DNS records are malicious or benign), providing a likelihood that a domain is malicious (e.g., a DNS hijacked record) or benign (e.g., not DNS hijacked), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign), receive risk signals (e.g., a signal pertaining to an endpoint risk for a network) from one or more other services or products, aggregate a set of risk signals (e.g., to obtain an aggregate risk score or to classify an endpoint), collecting network traffic information (e.g., comprising IP addresses, device information, etc.), determining IP-to-device mappings, filtering the IP-to-device mappings (e.g., for a particular network edge to identify a filtered set of IP-to-device mappings relevant to the particular network edge), distributing to various network edge devices (e.g., data appliance 102) the filtered set of IP-to-device mappings relevant to the various network edge devices, distributing (e.g., to various network edge devices) policies to be enforced at the network edge(s), etc.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32 G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32 + Gigabytes of RAM, and one or more Gigabit network interface adapters) that runs commercially available virtualization software, such as VMware Six, Citrix eServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

According to various embodiments, security platform 140 comprises Network traffic classification service 138 and/or IoT policy enforcement service 170. Security platform 140 may include various other services/modules, such as a malicious file detector, a malicious traffic detector, a parked domain detector, a DNS hijacked domain or DNS record detector, a DNS traffic classifier, an application classifier or other traffic classifier, etc. Network traffic classification service 138 is used in connection with analyzing network traffic (e.g., websites, domains, sample files, etc. pertaining to the network traffic) and/or automatically detecting malicious network traffic. IoT policy enforcement service 170 is used in connection with determining a security posture for endpoints connected to a network. IoT policy enforcement service 170 can obtain a set of risk signals and classify an endpoint, such as by grouping the endpoint to a particular group based on a determination that a set of risk signals for the endpoint

In some embodiments, IoT policy enforcement service 170 comprises one or more of IP-to-device mapping module 172, mapping filtering module 174, mapping distribution module 176, and/or policy distribution module 178.

IoT policy enforcement service 170 uses IP to device mapping module 172 to map IPs to devices. For example, network edge devices, such as ION devices, firewalls, security entities, etc. can perform an inline tagging of network traffic to include information pertaining to the device identifier associated with the network traffic. The network edge device can receive network traffic from a source device that is local to the particular network edge and provide information pertaining to the network traffic to security platform 140 (e.g., IoT policy enforcement service 170), such information comprising an IP address for the source device and a device identifier for the source device (e.g., a serial number, a MAC identifier, a device type, etc.). In some embodiments, in response to receiving network traffic at a network edge device (e.g., a gateway such as an ION device, a firewall, etc.), the network edge device obtains from the network traffic a destination IP address and/or a destination device identifier or type. The network edge device can provide the destination device information (e.g., the destination IP address, the destination device name or other identifier, and/or the destination device type, etc.). In response to receiving the network traffic information, IP-to-device mapping module 172 stores an association between IP addresses and devices (e.g., an association between an IP address for a source device and a device identifier or type for the source device), such as in a mapping of IPs-to-devices, etc.

In some embodiments, IP-to-device mapping module obtains network information for a particular device. In contrast to typical IT devices such as laptop computers that perform a wide variety of tasks, IoT devices tend to be purpose-built with a narrowly defined set of functions. As a result, IoT devices generate unique, identifiable patterns of network behavior. The system (e.g., security platform 140 or IoT policy enforcement service 170) can implement machine learning and AI, to recognize these behaviors and identify the devices on the network, creating a rich, context-aware inventory that is dynamically maintained and always up to date. According to various embodiments, IoT policy enforcement service 170 obtains network traffic, extracts an IP address from the network traffic (e.g., a source device IP) and classifies the network traffic to determine the particular source device or otherwise identify the source device (e.g., determine a source device type). IoT policy enforcement service 170 can then store the association between the IP address and the device information determined based on the network traffic (e.g., the device information determined based on a classification of the network traffic or the behaviors observed in the network traffic).

IoT policy enforcement service 170 uses mapping filtering module 174 to filter the mapping of IP-to-devices to obtain a subset of the mapping comprising a mapping of IP-to-devices for devices that are applicable for a particular network edge. According to various embodiments, IoT policy enforcement service 170 (e.g., mapping filtering module 174) configures a mapping of IPs-to-devices that are applicable for a particular network edge, such as to limit the IP-to-device mappings to be provided to a particular network edge device. For example, mapping filtering module 174 obtains an indication to determine IP-to-device mappings to be provided to a particular network edge, and in response to receiving the indication, determines a set of devices that are local with respect to the particular network edge. In some embodiments, mapping filtering module 174 additionally determines a set of remote devices for which mappings are to be provided to the particular network edge, for example, those devices remote with respect to the particular network edge but for which the system has defined an association with the particular network edge. The set of remote devices for which mappings are provided to the particular network edge may include remote devices that may access (or communicate with) a device that is local to the particular network edge.

IoT policy enforcement service 170 uses mapping distribution module 176 to provide (e.g., distribute, push, etc.) a set of mappings of IPs-to-devices to network edges, such as to network edge devices that may implement ION functionality and/or security functionality. In some embodiments, mapping distribution module 176 provides to a particular network edge a filtered mapping of IPs-to-devices comprising mappings for devices that are associated with the particular network edge. As an example, mapping distribution module 176 provides to a particular network edge the mapping of IPs-to-devices determined to be applicable to the particular network edge by mapping filtering module 174.

IoT policy enforcement service 170 uses policy distribution module 178 to provide (e.g., distribute, push, etc.) a set of one or more policies to network edges, such as to network edge devices that may implement ION functionality and/or security functionality. In some embodiments, policy distribution module 178 determines policies that are applicable to a particular network edge (e.g., a set of policies that are to be enforced at the network edge device), such as based on a set of devices associated with particular network edge (e.g., a set of local devices that connect to the network via the particular network edge and/or a set of remote devices that may attempt to access or communicate with a local device), a type of devices associated with the particular network edge, etc.

Network traffic classification service 138 may comprise an anomaly detector 146 (e.g., configured to detect anomalies in network traffic, file samples obtained by intercepting traffic, DNS traffic, or DNS records, etc.), a decision engine 152 (e.g., configured to predict whether network traffic, intercepted file samples, DNS traffic is malicious or whether a DNS record is DNS hijacked), domain profiles 156, and/or a similarity detector 144. In some embodiments, network traffic classification service 138 detects malicious network traffic or malware obtained from intercepted network traffic (e.g., by classifying a file sample obtained by a security entity or other network node requesting a maliciousness classification).

Network traffic classification service 138 can determine the classification for network traffic (e.g., a file sample obtained from network traffic, a DNS record, a DNS query, a DNS response, etc.) based at least in part on querying a classifier(s). The classifier that is queried to provide a classification of the network traffic sample associated with the network activity is a fingerprinting-based classifier, a heuristics-based classifier, another rule-based classifier, and/or a machine-learning based classifier. The classifier may be trained based at least in part on historical samples (e.g., samples of network traffic samples extracted from network traffic). The classifier can be trained based at least in part on a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a neural network (NN), XGBoost, a convolutional neural network (CNN), and LLM etc. In some embodiments, the classifier implements a CNN.

According to various embodiments, security platform 140 may receive a query from a security entity (e.g., inline firewall, such as a next generation firewall) for a real-time or offline classification of a network traffic sample, such as a file.

According to various embodiments, in response to network traffic classification service 138 classifying the network traffic sample, system 100 handles the corresponding network traffic according to a predefined policy (e.g., a security policy). For example, in response to predicting that the network traffic sample corresponds to malicious network traffic, system 100 can cause the network traffic to be blocked or quarantined, etc. As another example, system 100 can cause traffic to/from a compromised host (e.g., the client system associated with the intercepted network traffic from which the malicious domain was extracted) to be quarantined or sinkholed, etc. (e.g., at least until an administrator actively configures system 100 to proceed with permitting traffic to/from the client system, such as in response to the compromised host being remediated).

According to various embodiments, in response to network traffic classification service 138 classifying the network traffic (e.g., the network traffic sample), system 100 handles the network traffic according to a predefined policy (e.g., a security policy). For example, the system queries a traffic handling policy to determine the manner by which the network traffic (e.g., network activity for a session associated with the network traffic sample) is to be handled. The traffic handling policy may be a predefined policy, such as a security policy, etc. The traffic handling policy may indicate that network traffic associated with certain domains or having certain characteristics/profiles is to be blocked and network traffic associated with other domains or having other characteristics/profiles is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed network traffic sample (e.g., a newly analyzed network traffic sample for a particular session), security platform 140 (e.g., network traffic classification service 138) sends an indication that network activity (e.g., other network traffic samples) associated with the session for which the network traffic sample is obtained are associated with, or otherwise correspond to, the determined classification. In the case that the determined classification for the network traffic sample is that the corresponding network sample (e.g., a file extracted from the network traffic) or network traffic/activity is malicious network traffic/activity, security platform 140 provides an indication that network traffic/activity associated with the session for which the network traffic sample is obtained is also to be handled according to whether the network traffic sample is malicious. Security platform 140 can provide an indication that network traffic matching the network traffic sample predicted to be malicious is to be handled as malicious network traffic. For example, security platform 140 determines (e.g., computes) a signature or identifier for the network traffic/activity (e.g., a hash or other signature, or identifier for the corresponding network session), and sends to a network node (e.g., a security entity, an endpoint such as a client device, etc.) an indication of the classification associated with the signature (e.g., an indication whether the network traffic/activity is a malicious or non-malicious). Security platform 140 may update a mapping of signatures to network traffic sample classifications and provide the updated mapping to the security entity. In some embodiments, security platform 140 further provides to the network node (e.g., security entity, client device, etc.) an indication of a manner by which network traffic/activity matching the network traffic sample or otherwise be associated with the same session as the network traffic sample classified as malicious or matching the signature is to be handled. For example, security platform 140 provides to the security entity a traffic handling policy, a security policy, or an update to a policy.

According to various embodiments, network traffic classification service 138 determines whether the network traffic sample has sufficient information with which to determine whether the network traffic activity (e.g., the network traffic associated with the session from which the network traffic sample is obtained) is malicious (e.g., to predict a maliciousness classification for the file sample or network traffic). In some embodiments, network traffic classification service 138 determines whether the network traffic sample has sufficient information with which to determine whether the network traffic activity based on a confidence associated with a maliciousness classification. For example, if the confidence for the predicted maliciousness classification is less than a predefined confidence threshold, network traffic classification service 138 can determine that the network traffic sample does not comprise sufficient information. Conversely, the confidence for the predicted maliciousness classification is greater than (or equal to or greater than) the predefined confidence threshold, network traffic classification service 138 (e.g., decision engine 152) can determine that the network traffic sample comprises sufficient information. In some embodiments, network traffic classification service 138 determines whether the network traffic sample comprises sufficient information based on one or more heuristics or other predefined rules.

In response to determining that the network traffic sample does not comprise sufficient information with which to classify the associated network traffic/activity, network traffic classification service 138 can cause the network traffic/activity associated with the network traffic sample to be monitored further. For example, network traffic classification service 138 instructs (e.g., provides an indication) to the security entity (e.g., an inline firewall) from which the network traffic sample is obtained to further monitor network traffic/activity for the corresponding session. In response to receiving an indication from network traffic classification service 138 to further monitor the network traffic/activity for the session associated with the network traffic sample, the security entity can continue to monitor the network traffic activity, identify network traffic samples, determine network traffic samples that are suspicious (e.g., detect suspicious network activity), and query security platform 140 for a further maliciousness classification.

According to various embodiments, in response to determining the maliciousness classification for a network traffic sample (e.g., obtaining the predicted maliciousness classification, such as from a classifier), network traffic classification service 138 provides an indication of the maliciousness classification, such as to the applicable security entity (e.g., the security entity that provided the network traffic sample or a security entity mediating network traffic for the session associated with the network traffic sample).

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

DNS hijacked domains, for example, can be domains that are scams, phishing sites, or sites used to distribute C2 exploits or malware.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within enterprise network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www. example. com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *. badsite. com and client device 104′s request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides the security entity with an update of a mapping of signatures to applications (e.g., application identifiers).

FIG. 2 is a block diagram of a system for enforcing policies at a network edge according to a set of relevant mappings of IP addresses to IoT devices according to various embodiments. In some embodiments, system 200 implements at least part of system 100 of FIG. 2 and/or system 400 of FIGS. 4A and 4B. System 200 can implement one or more of processes 500-900 of FIGS. 5-9.

In the example shown, system 200 comprises network element 205 and network element 215. Network element 205 and network element 215 are network edge devices, such as devices that implement ION device functionality. Network element 205 and network element 215 may additionally implement security service functionality, such as next generation firewall. As illustrated, network element 205 and network element 215 may have a set of devices (e.g., IoT devices) connected thereto.

Network element 205 has a set of local devices associated therewith. For example, network element 205 provides service for a local branch/site 210 which may comprise a plurality of local devices. In the example illustrated, IoT device 212 (e.g., a camera) and IoT device 214 (e.g., a robotic arm) connect to a network (e.g., an enterprise network) via network element 205.

Network element 215 has a set of local devices associated therewith. For example, network element 215 provides for a local branch/site 220 which may comprise a plurality of local devices. In the example illustrated, IoT device 222 (e.g., a camera) and IoT device 224 (e.g., a robotic arm) connect to a network (e.g., an enterprise network) via network element 215.

According to various embodiments, a network element (e.g., a network edge device) provides network traffic, or information pertaining to the network traffic to system 200. For example, the network elements can provide network traffic log information (e.g., advanced application logs) for the respective devices connecting to the network through the network elements. In the example shown, network element 215 provides log information 225 to logging service 230.

In some embodiments, system 200 further comprises an IoT security service 240. IoT security service 240 can obtain the network traffic log from logging service 230. For example, IoT security service 240 obtains from logging service 230 streaming data comprising the log information. In response to receiving the streaming data, IoT security service 240 analyzes the log information to determine information pertaining to IoT devices connected to the network. In some embodiments, IoT security service 240 analyzes the log information to obtain behavior information, etc. The IoT security service 240 can determine (e.g., derive or otherwise infer) device information based on the log information generally and/or specifically, the behavior information. For example, IoT security service 240 can determine one or more of a device identifier (e.g., name, serial number, MAC address, etc.), a device type, an IP address, etc.

System 200 uses the information obtained from the log information to determine a corresponding IP-to-device mapping and/or policy information. In some embodiments, IoT security service 240 determines one or more policy recommendations. The one or more policy recommendations may include an indication of one or more policies to be enforced with respect to a device (e.g., an IoT device connected to a branch/site). According to various embodiments, at least a subset of the IP-to-device mappings are provided to the network elements (e.g., a network edge device, such as network element 205, network element 215, etc.), such as for use in connection with enforcement of one or more policies. As an example, the subset of the IP-to-device mappings provided to a particular network element (e.g., a network edge device) comprises mappings for IoT devices applicable to the corresponding network edge. Mappings for IoT devices applicable to the corresponding network edge can comprise a set of local devices (e.g., devices local to the particular network edge device). The mappings for IoT devices applicable to the corresponding network edge may further comprise a set of remote devices (e.g., devices remote to the particular network edge device), such as remote devices that may attempt to connect to (or communicate with) a device local to the network edge. The set of remote devices applicable to a particular network edge (e.g., associated with the network edge device) may be determined based on a negotiation of IoT devices or inferred based on the network traffic information (e.g., log information).

In the example shown, system 200 further comprises controller 250 (e.g., an SDWAN controller). Controller 250 obtains the IP-to-device mappings from IoT security service 240. In addition, controller 250 may obtain one or more policy recommendations, such as an indication of one or more policies to be applied with respect to a particular device type, an indication of one or more policies to be applied with respect to a particular device identifier, etc.

According to various embodiments, controller 250 provides to various network edge devices (e.g., network element 205, network element 215, etc.) an indication of IP-to-device mappings relevant to a particular network edge device. For example, controller 250 determines the mappings to be provided to a particular network edge device based on determining the devices (e.g., the IoT devices) associated with (or relevant to) the particular network edge. In some embodiments, the mapping of IPs-to-devices provided to the particular network edge comprises a set of devices that are local to the particular network edge. The mapping of IPs-to-devices provided to the particular network edge device comprises a set of remote devices deemed associated with (or relevant to) the particular network edge, such as remote devices that may attempt to access a local device (e.g., a device local to the particular network edge device) or that may be accessed by a local device.

In some embodiments, the set of mappings of IPs-to-devices provided to a particular network edge device does not comprise mappings of IPs-to-devices for devices that are remote with respect to the particular edge and not relevant to the particular network edge device (e.g., remote devices that are deemed to be not associated with the particular network edge device such as remote devices that do not access devices local to the network edge device or are not expected to access a local device, etc.).

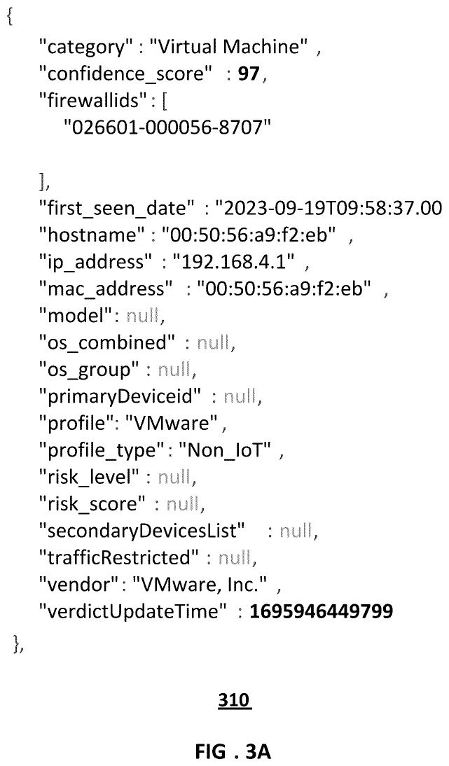

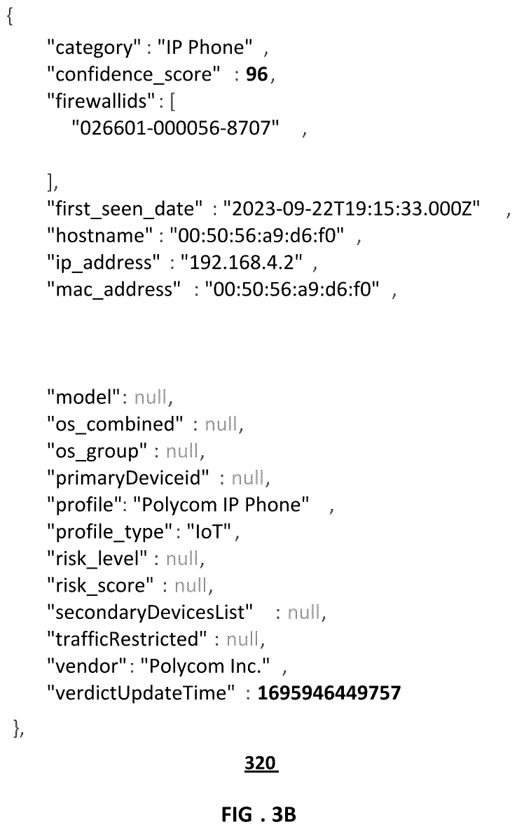

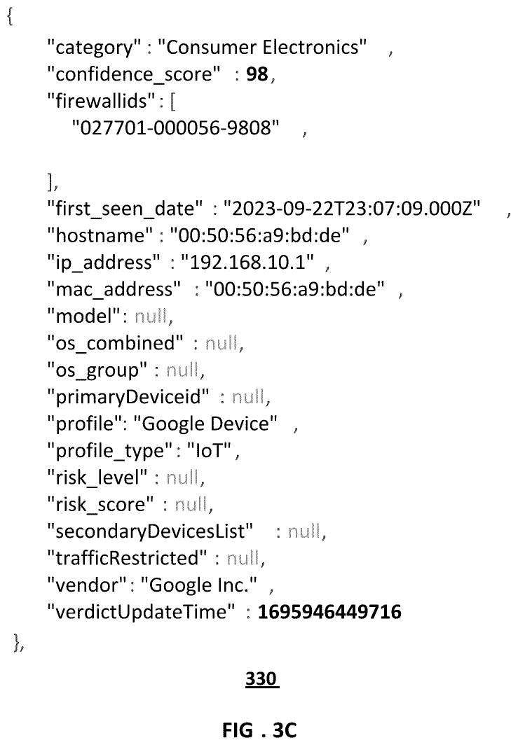

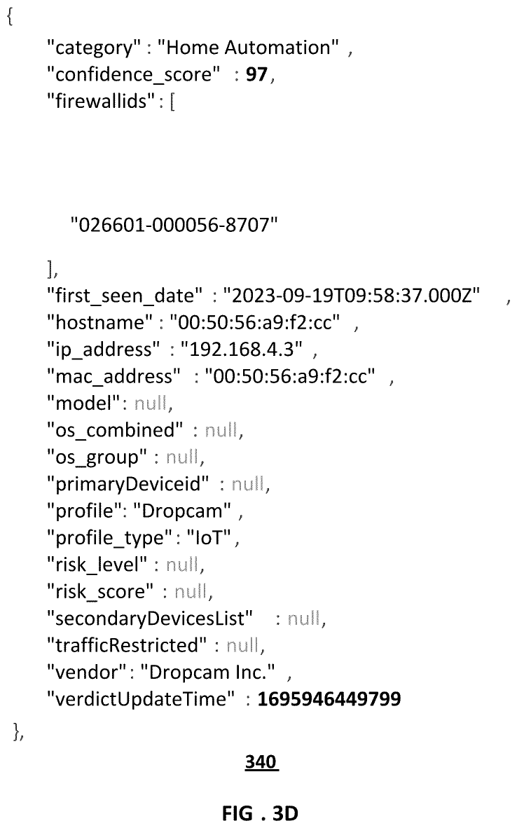

FIGS. 3A-3D are examples of IP to device mappings according to various embodiments. According to various embodiments, the system (e.g., a central controller that provides mappings to network edge devices such as ION devices, security entities, etc.) stores device profiles or IP-device mappings, such as IP-device mappings 310, 320, 330, and 340. The system can derive the IP-device mappings based on network traffic. For example, the system can determine (e.g., infer) information pertaining to the device based on the network traffic such as the network behavior. In the example shown in FIG. 3A, IP-device mapping 310 stores a mapping of IP address 192.168.4.1 to one or more of: (a) a device profile (e.g., “VMware”), (b) a device profile type (e.g., “Non_IoT”), (c) a MAC address (e.g., 00:50:56:a9:f2:eb), etc. The system may additionally store category information in association with the IP-device mapping. In the example shown in FIG. 3B, IP-device mapping 320 stores a mapping of IP address 192.168.4.2 to one or more of: (a) a device profile (e.g., “Polycom IP phone”), (b) a device profile type (e.g., “IoT”), (c) a MAC address (e.g., 00:50:56:a9:d6:f0), etc. In the example shown in FIG. 3C, IP-device mapping 330 stores a mapping of IP address 192.168.10.1 to one or more of: (a) a device profile (e.g., “Google Device”), (b) a device profile type (e.g., “IoT”), (c) a MAC address (e.g., 00:50:56:a9:bd:de), etc. In the example shown in FIG. 3D, IP-device mapping 340 stores a mapping of IP address 192.168.4.3 to one or more of: (a) a device profile (e.g., “Dropcam”), (b) a device profile type (e.g., “IoT”), (c) a MAC address (e.g., 00:50:56:a9:f2:cc), etc.

FIGS. 4A and 4B are collectively a block diagram of a system for enforcing policies at a network edge according to a set of relevant mappings of IP addresses to IoT devices according to various embodiments. In some embodiments, system 400 implements at least part of system 100 of FIG. 2 and/or system 200 of FIG. 2. System 400 can implement one or more of processes 500-900 of FIGS. 5-9.

In the example shown, system 400 comprises a plurality of network edge devices to provide ION device functionality, such as network element 425 and 450. The plurality of network edge devices respectively enforce policies with respect to applicable devices (e.g., with respect to network traffic for the applicable devices). The policies may be enforced based on a device identifier and/or based at least in part on a characteristics of the device. For example, the policies may be defined to enforced with respect to a particular device type, a particular device category, a particular device name, etc. System 400 may additionally comprise controller 405 that is configured to provide the network edge devices with applicable IP-to-device mappings (e.g., mappings for devices associated with the corresponding network edge device). Controller 405 may also provide the network edge devices with the policies to be enforced at the network edge device. For example, controller 405 determines a set of devices associated with the network edge device (e.g., devices local to the network edge, or remote devices that are expected to connect to or communicate with a local device, etc.) and determines one or more policies that are to be enforce with respect to the set of devices.

According to various embodiments, IP-device mapping (also referred to herein as an IP-to-device mapping) is important for network security and policy enforcement, such as for enforcing a device identifier (also referred to herein as a DeviceID) based policies. A network entity (e.g., an ION device, a security entity, etc.) in one particular location may learn an IP-to-device mapping but may not be learned by a network entity at another location. This IP-to-device mapping may be needed by other elements at different locations as well to enforce DeviceID based policies. For example, if a device A is located in a datacenter and a policy (e.g., a policy for restricting user access to device A) is to be enforced in a branch (e.g., by another network entity), then in such cases, the branch needs to know the IP-to-device mapping for device A to enforce policy at the branch.

According to various embodiments, the system comprises a service (e.g., an IoT service) that learns IP-to-device mappings from IoT devices associated with (e.g., connected to a network). The service may learn all the IP-to-device mappings for IoT devices. For example, various network entities (e.g., ION devices, security entities, etc.) can provide (e.g., to a logging service) log data associated with network traffic. The service can analyze the log data determine an IP-to-device mapping based on the log data (e.g., the service can identify the source IP address and the source device or type of source device, etc.).

Related art systems maintain an IP-to-device mapping for a set of devices. Such systems distributes all the mappings to every security entity (e.g., a firewall) for policy enforcement. This can pose lot of challenges, for example, (a) scale challenge with respect to network and compute cost, (b) the security entities are required to perform unnecessary processing of all IP-to-device mappings even when the policy is not configured with those DeviceID, (c) the number of entries that can be stored at a security entity at any given time may be limited (e.g., the security entity may have limited storage space), and (d) the system does not support overlapping IP for IoT in the firewalls. At scale, the distribution of all IP-to-device mappings (e.g., for every device connected to the network) becomes extremely large and burdensome for the various security entities (or ION devices) within the network to enforce policies.

According to various embodiments, system 400 classifies devices (e.g., with respect to a particular network entity such as an ION device or security entity) as local devices or remote devices. For example, the system classifies a device as local to a particular network entity (e.g., ION device or security entity, etc.) or as remote with respect to the particular network entity. The system can obtain a set of predefined policies. A policy can specify both source and destination DeviceIDs. In response to classifying the devices and obtaining the set of predefined policies, system 400 can distribute policies to the various network entities (e.g., ION devices, security entities, etc.). In some embodiments, system 400 distributes policies and/or IP-to-device mappings that are relevant for a particular network element. For example, system 400 can distribute policies and/or IP-to-device mappings that are specific for the particular network element. Different network elements may receive different sets of IP-to-device mappings or policies.

According to various embodiments, the system comprises a centralized controller or centralized service. In the example shown, system 400 comprises controller 405 (e.g., a centralized SDWAN controller). The centralized controller is used to obtain IP-to-device mappings and to filter out the IP-to-device mappings that the centralized controller is to distribute to a particular network entity, such as network element 425 or network element 450 (e.g., ION devices). Controller 405 may obtain the IP-to-device mappings based on an IoT cloud security service 410. In the example shown, IoT cloud security service 410 comprises an IoT service 414 that provides a set of IP-to-device mappings to controller 405.

In some embodiments, controller 405 further stores, or has access to, a set of set of policies. Controller 405 can store a set of rules or parameters that define the contexts for which a particular policy or set of policies is to be enforced. For example, controller 405 can store an indication of a particular device or type of devices for which the policy is to be enforced. As another example, controller 405 may store an indication of a particular site for which the policy is to be enforced. In the example shown, controller 405 stores policy mappings 415 that comprises a mappings of policies to contexts for which the policies are to be enforced. As illustrated, policy mappings 415 comprises (a) a mapping that a policy identified as Policy1 is to be applied when (e.g., for network traffic where) a source device (e.g., source DeviceID) is a Polycom IP phone, (b) a mapping that a policy that identified as Policy2 is to be enforced when (e.g., for network traffic where) a destination device is a Dropcam; (c) a mapping that a policy identified as Policy3 is to be enforced when (e.g., for network traffic where) the source device is a Google device; (d) a mapping that Policy1 and Policy2 are to be applied for network sites Site1 and Site2, and (e) a mapping that Policy3 is to be applied for Site1.

In some embodiments, an IP-Device mapping comprises the unique identifier of the element from which the mapping is learnt, for example, the serial number of the element or the ID of the element. The system (e.g., controller 405, IoT cloud security service 410, etc.) can infer that the device associated with the IP-Device mapping is associated with (e.g., behind or otherwise accessing the network through) the particular element associated with the unique which learnt the device characteristics and shared those device characteristics with IoT. Controller 405 determines the element with which a particular device is associated based on the element unique identifier comprised in the IP-Device mapping for the particular device. In response to determining the element with which a particular device is associated, controller 405 can determine to apply a policy at the element and/or push the IP-Device mapping to that element. This technique for associating devices with elements can also help to support overlapping IPs in the network. For example, in the case the unique identifier of the element is no longer valid (e.g., due to RMA), controller 405 can identify the element based on the IP address. Controller 405 can use the IP-Device mappings obtained from IoT cloud security service 410 to have the complete visibility of the network, for example, to identify the IP address belonging to each site/branch/element.

According to various embodiments, controller 405 determines the policies and/or IP-Device mappings to provide to a network element (e.g., an ION device), such as network element 425 or network element 450 based at least in part on a policy configuration. As an example, the policy configuration or definition indicates a device(s) or types of devices for which a policy is to be enforced or a site(s) (e.g., a network element(s)) for which the policy is to be enforced (e.g., a network element that is to enforce the particular policy). Controller 405 determines provides (e.g., pushes) to a particular network element (e.g., an ION device, a firewall, etc., such as for a particular site/branch/element) the IP-Device mappings for a particular device (e.g., matching a particular DeviceID) based on determining that the device is associated with the particular network element (e.g., based on determining from the IP-Device mapping that the device is associated with the particular network element). In some embodiments, controller 405 only provides to a particular network element only IP-Device mappings for devices associated with the particular network element (e.g., source devices that are behind the particular network element, a destination device that a device behind the network element is expected to interact with, etc.).

Controller 405 can distribute (e.g., push) to a particular network element those IP-Device mappings for devices associated with the particular network element. Controller 405 provides to a particular network element IP-Device mappings for local users belonging to that particular site/element/branch (e.g., all local users or devices for the local users belonging to the network element). As an illustrative example, if an enterprise has 1 million devices but only 10k of those devices are behind a network element for a first branch (e.g., Branch1), controller 405 will push only these 10k IP-Device mappings to Branch 1. This can also help in visibility of the device type for a given IP flow. In some embodiments, controller 405 only pushes to a particular network element the IP-Device mappings for devices behind the network element, except to the extent that controller 405 stores a policy configuration(s) that indicates a destination device (e.g., a DeviceID for a destination device) associated with the network element, such as a destination device with which a source device behind the particular network element is expected to communicate.

In some embodiments, controller 405 provides to a particular network element the IP-Device mappings for devices that are remote with respect to the particular network element but that are associated with the particular network element, such as in the case that a local device for the particular network element is expected (or has been observed) to communicate with the local device. For example, the controller 405 can provide to the particular network element the IP-Device mappings of remote device(s) based on a determination that a policy configuration comprises the remote device(s) as destination devices (e.g., destination DeviceIDs). With respect to remote devices relative to a particular network element, controller 405 can distribute only necessary IP-Device mappings of remote devices that are useful at a given site/element/branch. This is useful for any policy defined with a destination DeviceID of remote devices. As an illustrative example, if a policy is defined as: Deny UserA to Access Printer-Vendor-A, then Printer-Vendor-A is the destination DeviceID in this policy. Controller 405 can push all IP-Device Mappings that match Printer-Vendor-A to that particular site/element/branch.

In contrast to current next generation firewalls, controller 405 does not need to push all the IP-Device mappings for enforcement of the applicable policies. Controller 405 only provides the IP Device mappings for a set of local devices associated with a particular network element and a set of remote devices associated with the particular network element. In connection with determining the IP-device mappings to provide to a particular network element, controller 405 filters out all IP-device mappings to obtain only those IP-device mappings for devices (e.g., local or remote) that are associated with the particular network element.

According to various embodiments, system 400 uses inline tagging in network packets to carry the device information as context. For example, in response to receiving a network packet from a device (e.g., a local device), the network element (e.g., an ION device) tags the network packet with information for the device. The inline tagging is useful for enforcement of any policy defined with a source DeviceID of remote devices. As an illustrative example, if DeviceA is behind Branch1, and a policy is defined on Branch2 as: deny everything from DeviceA, then in this case, DeviceA is the source DeviceID for enforcement of the policy at Branch 2. The network element at Branch1 can perform an inline tagging of device information for Device A so the DeviceA context is carried from Branch1 to Branch2. In response to receiving the network packet, Branch2 can obtain the context and handle the network packet accordingly (e.g., by applying the policy accordingly).

Controller 405 can manage or obtain policies or indication of policies that are to be enforced for system 400. As an illustrative example, when Policy1, Policy2 and Policy3 are created with SrcDevice criteria, controller 405 pushes that information to respective sites. As shown in FIGS. 4A and 4B, network element 450 (e.g., Site1 ION device) comprises (e.g., locally stores) a set of IP-Profile mappings 455 and a set of IP-Device mappings 465. Network element 450 stores three ID-Profile mappings. Similarly, network element 425 comprises a set of IP-Device mappings 435 and a set of IP-Profile Mappings 430. As shown, network element 425 (e.g., Site2 ION device) has two ID-Profile mappings based on the policy configuration(s).

Controller 405 obtains a set of IP-Device mappings from IoT cloud security service 410. In response to obtaining (e.g., receiving) IP-Device mappings, controller 405 adds the IP-Device mappings to a database (e.g., a local database). Each IP-Device mapping can be stored in connection with unique device IDs. Controller 405 determines a set of IP-Device mappings to provide (e.g., to push to) a network element based at least in part on implementing a filtering based on IP addresses, such as an IP address for the network element or IP addresses of devices local to the network element. Controller 405 correspondingly provides the appropriate IP-Device mappings to corresponding sites. In the example shown, controller 405 pushes IP-Device mapping of all three devices with IP subnet 192.168.4.0/24 to network element 450 (e.g., Site1 ION device). Similarly, controller 405 provides to network element 425 one IP-Device mapping of with IP Subnet 192.168.1.0/24 (e.g., for the device local to network element 425 having an IP address of 192.168.10.1) and another IP-Device mapping for a remote device (e.g., a Dropcam profile having an IP address of 192.168.4.3) because the remote device is set as DstDevice in a policy to be enforced at network element 425 (e.g., Policy2). Controller 405 determines the IP-Device mappings (e.g., all IP-Device mappings) matching the destination profile and pushes those IP-Device mappings to sites (e.g., network elements) where this policy is configured (e.g., to be enforced).

In some embodiments, controller 405 provides to a particular network element those IP-Device mappings for local devices irrespective of whether a particular policy is configured to be enforced at the particular network element. In the example shown, controller 405 provides to network element 450 the IP-Device mapping 470 for the device with 192.168.4.1 having a VMware profile even though the device is not identified in any currently defined policy (e.g., any policy in policy mappings 415). Contr405 may also provide network element 450 with ID-Profile mapping for the VMware device when this information is determined from the IP-Device mapping.

In some embodiments, a network element (e.g., network element 450) enforces a policy with respect to network traffic inbound to the network (e.g., LAN-to-WAN network traffic for network traffic received from a local device) if the device identifier associated with the network traffic matches the source device (e.g., Src Device) information in the particular policy. Using the example shown, when network element 450 receives traffic from the IP address 192.168.4.2 to any destination, network element 450 will match Policy1 (e.g., will enforce Policy1 for the network traffic) because the device associated with IP address 192.168.4.2 is, according to the IP-Device mappings 465 stored at network element 450, associated with device profile identifier 16100645914280238 which is a Polycom IP phone according to the ID-Profile mapping 455 stored at network element 450. Policy1 (as shown at policy mappings 415) is enforced when the SrcDevice is a Polycom IP Phone, and thus network element 450 applies Policy1 for network traffic from the IP address 192.168.4.2.

Conversely, if network traffic inbound to the network received at a network element does not enforce a policy having a source device identifier (e.g., a SrcDevice ID) matching the device associated with the inbound network traffic, then the network element does not enforce a policy for the traffic based on the source device information (e.g., a policy may still be enforced if the destination device information matches the policy configuration). Using the example shown, when network element 450 receives traffic from 192.168.4.1 to any destination, this network will not match any policy with specific DeviceID, however, network element 450 will match such network traffic with any other matching policy configured to be applicable for “any” src Device. Even though this network traffic does not match any policy, this device_verdict_id can be stored/set in flow records which can be used for visibility.

In some embodiments, a network element (e.g., network element 450) enforces a policy with respect to network traffic received from a remote device (e.g., WAN-to-LAN network traffic for network traffic received from another site based on network traffic for a remoted device) if the device identifier associated with the network traffic matches the destination device (e.g., DstDevice) information in the particular policy. Using the example shown, when network element 450 receives traffic from any source to destination 192.168.4.3 that is behind network element 450 (e.g., the Site1 ION device), network element 450 will match Policy2 (e.g., will enforce Policy2 for the network traffic) because the device associated with IP address 192.168.4.3 is, according to the IP-Device mappings stored at network element 450, associated with device profile identifier 16100645914280349 which is a Dropcam according to the ID-Profile mapping 455 stored at network element 450. Policy2 (as shown at policy mappings 415) is enforced when the DstDevice is a Dropcam, and thus network element 450 applies the Policy2 for network traffic destined for the IP address 192.168.4.3.

In some embodiments, a network element (e.g., network element 450) enforces a policy with respect to network traffic received from a remote device (e.g., WAN-to-LAN network traffic for network traffic received from another site based on network traffic for a remoted device) if the device identifier associated with the network traffic matches the source device (e.g., SrcDevice) information in the particular policy. Using the example shown, when traffic originated from network element 425 (e.g., inbound network traffic at Site2 ION device) has a source IP address of 192.168.10.1 to any IP address behind network element 450 (e.g., Site1 ION device), the device_profile_id “16100645914280440” (e.g., the device_profile_id associated with the particular source IP address) will be carried as metadata (e.g., GENEVE metadata) in the packet (e.g., based on inline tagging implemented at network element 425). Once the traffic is received at network element 450 (e.g., Site1 ION device), it parses the metadata and obtains the device_profile_id and checks for any matching policy. In this example, network element 450 will determine that Policy3 matches the network traffic because the device_profile_id is associated with a Google Device, which is identified as the source device for which Policy3 is to be enforced (as shown at policy mappings 415). Network element 450 correspondingly enforces Policy 3.

In some embodiments, a network element (e.g., network element 425) enforces a policy with respect to network traffic inbound to the network (e.g., LAN-to-WAN network traffic for network traffic received from a local device) if the destination information for the network traffic matches the destination device (e.g., Dst Device) information in the particular policy. Using the example shown, when network element 425 receives traffic from the IP address having a destination IP address of 192.168.4.3, network element 425 matches the network traffic to Policy2. For example, network element 425 performs a lookup with respect to IP-device mappings 435 to determine that the device associated with IP address 192.168.4.3 a device_profile_id of 16100645914280349. Network element 425 can then perform a lookup in IP-profile mapping 430 to determine that this device_profile_id associated with the inbound network traffic is a Dropcam. Network element 425 matches the network traffic to Polic2 (e.g., determines that Policy2 is to be enforced for the network traffic) because the destination IP address corresponds to a Dropcam and policy configuration for Policy2 (as shown in policy mappings 415) indicates that Policy2 is to be enforced when the DstDevice matches Dropcam. Network element 425 can thus enforce traffic destinated for a remote device and implement a zero trust network access model.

The network elements (e.g., the ION devices) can report/provide flow logs to IoT service 414. IoT service can process these flow logs and provide the IP-Device mappings to controller 405. When sending flow logs from the ION devices to controller 405, system 400 (e.g., the ION devices) insert the device identifier d in the device field of flow record. This can be used for visibility of the device type for a given IP in the flow.

FIG. 5 is a flow diagram of a method for providing a mapping of IPs to IoT devices associated with a particular network edge according to various embodiments. According to various embodiments, process 500 is implemented at least in part by system 100 of FIG. 1, system 200 of FIG. 2, and/or system 400 of FIGS. 4A and 4B.

In some embodiments, process 500 is implemented by a system that provides IP-Device mappings to network edge devices (e.g., an ION device, a firewall, etc.).

At 505, the system determines an IP-device mappings for a set of IoT devices. At 510, the system filters the IP-device mappings for a subset of IoT devices associated with a particular network edge to obtain a mapping of IPs to IoT devices associated with the particular network edge. At 515, the system provides to the particular network edge the mapping of IPs to IoT devices associated with the particular network edge. At 520, the system causes a relevant policy to be applied at the particular network edge based on the subset of IoT devices associated with the particular network edge. At 525, a determination is made as to whether process 500 is complete. In some embodiments, process 500 is determined to be complete in response to a determination that no further mappings of IPs to IoT devices are to be provided to network edges (e.g., ION device, a security entity, etc.), no further ION devices are to be configured, an administrator indicates that process 500 is to be paused or stopped, etc. In response to a determination that process 500 is complete, process 500 ends. In response to a determination that process 500 is not complete, process 500 returns to 505.

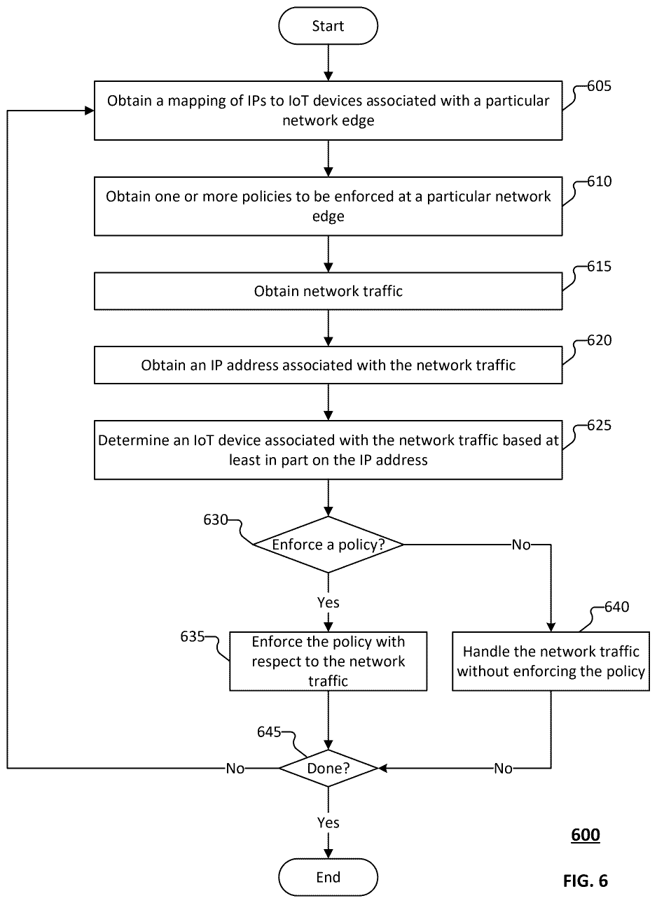

FIG. 6 is a flow diagram of a method for enforcing a policy with respect to network traffic based on a mapping of IPs to IoT devices associated with a particular network edge according to various embodiments. According to various embodiments, process 600 is implemented at least in part by system 100 of FIG. 1, system 200 of FIG. 2, and/or system 400 of FIGS. 4A and 4B.

In some embodiments, process 600 is implemented by a particular network edge, for example, an ION device, a firewall, etc.

At 605, the system obtains a mapping of IPs to IoT devices associated with a particular network edge. At 610, the system obtains one or more policies to be enforced at a particular network edge. At 615, the system obtains network traffic. At 620, the system obtains an IP address associated with the network traffic. At 625, the system determines an IoT device associated with the network traffic based at least in part on the IP address. At 630, the system determines whether a policy is to be enforced with respect to the network traffic. For example, the system queries the policies being enforced by the system (e.g., at the site or at the ION device) for policies that are to be enforced for the IoT device associated with the network traffic. In response to determining that the policy is to be enforced, process 600 proceeds to 635 at which the system enforces the policy with respect to the network traffic. Conversely, in response to determining that the policy is not to be enforced, process 600 proceeds to 640 at which the system handles the network traffic without enforcing the policy.

At 645, a determination is made as to whether process 600 is complete. In some embodiments, process 600 is determined to be complete in response to a determination that no further traffic is to be handled, no further traffic is received, an administrator indicates that process 600 is to be paused or stopped, etc. In response to a determination that process 600 is complete, process 600 ends. In response to a determination that process 600 is not complete, process 600 returns to 605.

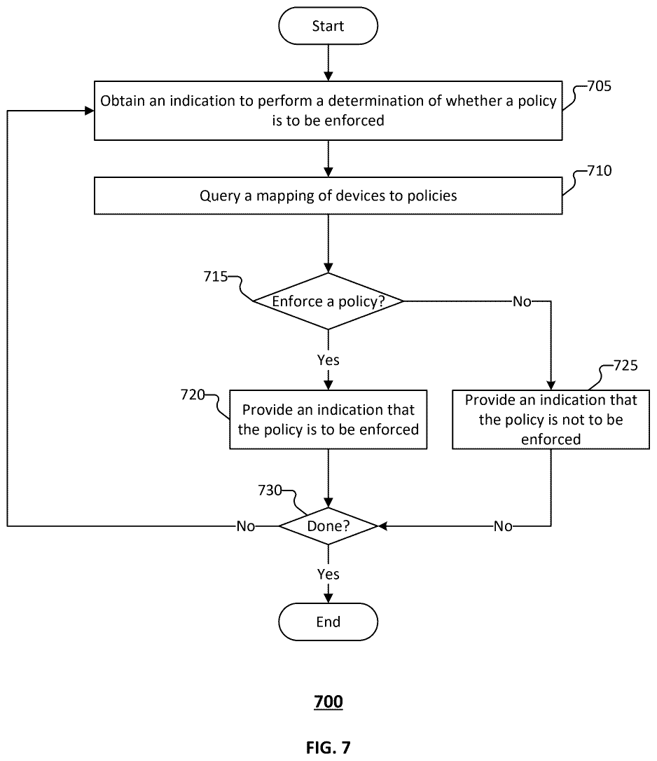

FIG. 7 is a flow diagram of a method for determining whether a policy is to be performed at a particular network edge according to various embodiments. According to various embodiments, process 700 is implemented at least in part by system 100 of FIG. 1, system 200 of FIG. 2, and/or system 400 of FIGS. 4A and 4B.

In some embodiments, process 700 is invoked in response to receiving network traffic for a device. For example, process 700 is implemented by a particular network edge, for example, an ION device, a firewall, etc.

At 705, the system obtains an indication to perform a determination of whether a policy is to be enforced. At 710, the system queries a mapping of devices to policies. At 715, the system determines whether the policy is to be enforced. In response to determining that the policy is to be enforced, process 700 proceeds to 720 at which the system provides an indication that the policy is to be enforced. Conversely, in response to determining that the policy is not to be enforced, the system provides an indication that the policy is not to be enforced. In some embodiments, the indication is provided to a service that causes policy to be enforced, such as a service running at an ION device, etc. At 730, a determination is made as to whether process 700 is complete. In some embodiments, process 700 is determined to be complete in response to a determination that no further network traffic is to be determined (e.g., at a particular network edge, for example, by an ION device), no further policies are to be evaluated to determine whether a policy is to be enforced for a particular network traffic sample, an administrator indicates that process 700 is to be paused or stopped, etc. In response to a determination that process 700 is complete, process 700 ends. In response to a determination that process 700 is not complete, process 700 returns to 705.

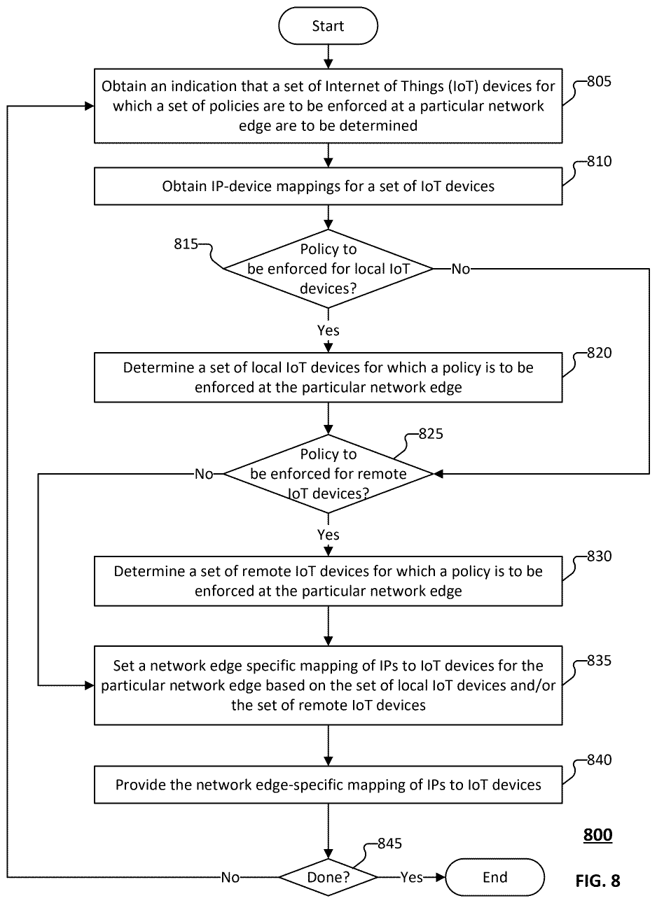

FIG. 8 is a flow diagram of a method for determining mapping of IPs to devices applicable for a particular network edge according to various embodiments. According to various embodiments, process 800 is implemented at least in part by system 100 of FIG. 1, system 200 of FIG. 2, and/or system 400 of FIGS. 4A and 4B.

In some embodiments, process 500 is implemented by a system that provides IP-Device mappings to network edge devices (e.g., an ION device, a firewall, etc.).

At 805, the system obtains an indication that a set of IoT devices for which a set of policies are to be enforced at a particular network edge is to be determined. At 810, the system obtains IP-device mappings for a set of IoT devices. At 815, the system determines whether a policy is to be enforced for local IoT devices. In response to determining that a particular network edge is to enforce a policy for a local IoT device at a particular network edge, process 800 proceeds to 820 and the system determines a set of local IoT devices for which a policy is to be enforced at the particular network edge. Conversely, in response to determining that no policy is to be enforced for local IoT devices at the particular edge, proceeds to 825. At 825, the system determines whether a particular network edge is to enforce a policy for remote IoT devices. In response to determining that the particular network edge is to enforce a policy for remote IoT devices, process 800 proceeds to 830 at which the system determines a set of remote IoT devices for which a policy is to be enforced at the particular network edge. Conversely, in response to determining that the particular network edge is not to enforce a policy for remote IoT devices, process 800 proceeds to 835. At 835, the system sets a network edge specific mapping of IPs to IoT devices for the particular edge based at least in part on the set of local IoT devices and/or the set of remote IoT devices. At 840, the system provides the network edge-specific mapping of IPs to IoT devices. At 845, a determination is made as to whether process 800 is complete. In some embodiments, process 800 is determined to be complete in response to a determination that no further mappings of IPs to IoT devices are to be provided to network edges (e.g., ION device, a security entity, etc.), no further ION devices are to be configured, an administrator indicates that process 800 is to be paused or stopped, etc. In response to a determination that process 800 is complete, process 800 ends. In response to a determination that process 800 is not complete, process 800 returns to 805.

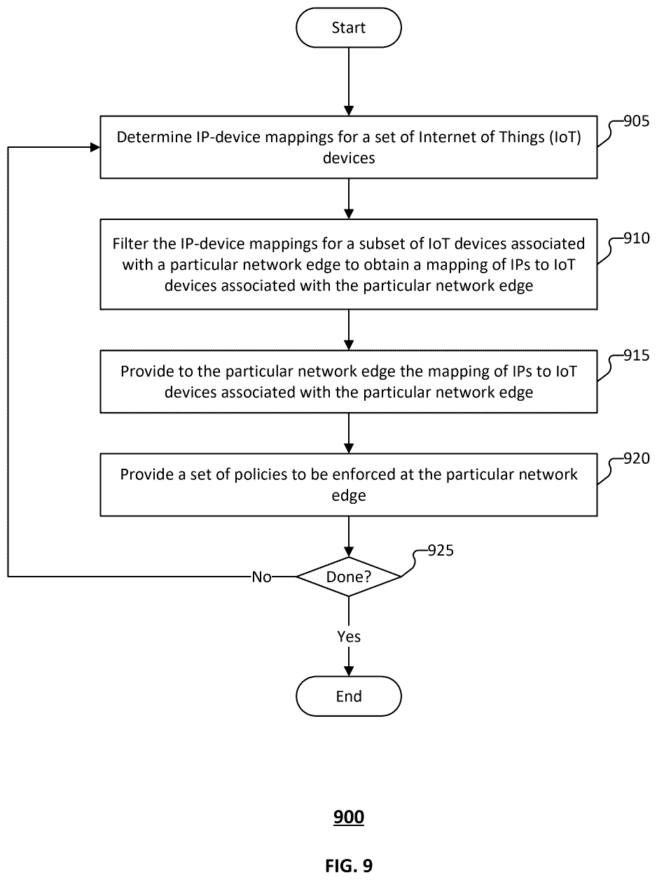

FIG. 9 is a flow diagram of a method for causing a set of policies to be enforced at a particular network edge based on a mapping of IPs to devices relevant for the particular network edge according to various embodiments. According to various embodiments, process 900 is implemented at least in part by system 100 of FIG. 1, system 200 of FIG. 2, and/or system 400 of FIGS. 4A and 4B.

In some embodiments, process 500 is implemented by a system that provides IP-Device mappings to network edge devices (e.g., an ION device, a firewall, etc.). The system can also provide a set of policies that are to be enforced at a particular network edge.

At 905, the system determines an IP-device mappings for a set of IoT devices. At 910, the system filters the IP-device mappings for a subset of IoT devices associated with a particular network edge to obtain a mapping of IPs to IoT devices associated with the particular network edge. At 915, the system provides to the particular network edge the mapping of IPs to IoT devices associated with the particular network edge. At 920, the system provides a set of policies to be enforced at the particular network edge. At 925, a determination is made as to whether process 900 is complete. In some embodiments, process 900 is determined to be complete in response to a determination that no further mappings of IPs to IoT devices are to be provided to network edges (e.g., ION device, a security entity, etc.), no further ION devices are to be configured, an administrator indicates that process 900 is to be paused or stopped, etc. In response to a determination that process 900 is complete, process 900 ends. In response to a determination that process 900 is not complete, process 900 returns to 905.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
determine IP-device mappings for a first set of Internet of Things (IoT) devices;
filter the IP-device mappings for a second set of IoT devices associated with a particular network edge to obtain a mapping of IPs to IoT devices associated with the particular network edge, wherein the second set of IoT devices is a subset of the first set of IoT devices;
provide to the particular network edge the mapping of IPs to IoT devices associated with the particular network edge;
cause a relevant policy to be applied at the particular network edge based on the second set of IoT devices associated with the particular network edge; and
a memory coupled to the one or more processors and configured to provide the one or more processors with instructions.

2. The system of claim 1, wherein a particular IP-device mapping comprises a unique identifier for a network element from which the particular IP-device mapping is learned.

3. The system of claim 2, wherein the unique identifier comprises a serial number for the network element.

4. The system of claim 2, wherein the network element is an Instant-On Network (ION) device.

5. The system of claim 1, wherein providing to the particular network edge the mapping of IPs to IoT devices associated with the particular network edge comprises:
distributing, by a software-defined wide area network (SD-WAN) controller, the mapping of IPs to IoT devices associated with the particular network edge to a network element for the particular network edge.

6. The system of claim 1, wherein an SD-WAN controller distributes to each network edge associated with an IoT device a corresponding mapping of IPs to IoT devices associated with that network edge.

7. The system of claim 1, wherein the relevant policy comprises a security policy.

8. The system of claim 1, wherein the relevant policy comprises an SD-WAN policy.

9. The system of claim 1, wherein a network element at the particular network edge performs an inline tagging of packets to include device information for the IoT device from which the packet is sent.

10. The system of claim 1, wherein causing the relevant policy to be applied at the network edge comprises:
selecting a set of one or more policies relevant to one or more of the second set of IoT devices associated with the particular network edge, wherein the set of one or more policies are selected based at least in part on the IP-device mappings; and
distributing a set of one or more policies to a network element at the network edge based at least in part on the second set of IoT devices associated with the particular network edge.

11. The system of claim 10, wherein the set of one or more policies comprise one or more of a local IoT policy or a remote IoT policy.

12. The system of claim 1, wherein the relevant policy includes a combination of local and global IoT device-related security policies.

13. The system of claim 12, wherein the relevant policy comprises a global IoT policy based on Zero Trust Network Access (ZTNA).

14. The system of claim 1, wherein the one or more processors are further configured to:
store a traffic log obtained from a security platform.

15. The system of claim 14, wherein the security platform is a next generation firewall (NGFW).

16. The system of claim 1, wherein the relevant policy corresponds to a policy for a source IoT device.

17. The system of claim 1, wherein the relevant policy corresponds to a policy for a destination IoT device.

18. The system of claim 1, wherein a particular IoT device is associated with a profile that is used in connection with selecting one or more relevant policies.

19. A method, comprising:
determining IP-device mappings for a first set of Internet of Things (IoT) devices;
filtering the IP-device mappings for a second set of IoT devices associated with a particular network edge to obtain a mapping of IPs to IoT devices associated with the particular network edge, wherein the second set of IoT devices is a subset of the first set of IoT devices;
providing to the particular network edge the mapping of IPs to IoT devices associated with the particular network edge; and
causing a relevant policy to be applied at the particular network edge based on the second set of IoT devices associated with a network at the particular network edge.

20. A computer program product embodied in a non-transitory computer readable medium and comprising computer instructions for:
determining IP-device mappings for a first set of Internet of Things (IoT) devices;
filtering the IP-device mappings for a second set of IoT devices associated with a particular network edge to obtain a mapping of IPs to IoT devices associated with the particular network edge, wherein the second set of IoT devices is a subset of the first set of IoT devices;
providing to the particular network edge the mapping of IPs to IoT devices associated with the particular network edge; and
causing a relevant policy to be applied at the particular network edge based on the second set of IoT devices associated with the particular network edge.
